(19) United States
(12) Patent Application Publication
(10) Pub. No.: US 2018/0270543 A1
(43) Pub. Date: Sep. 20, 2018

(54) SYSTEM AND METHOD FOR PROVIDING A PLATFORM FOR OPTIMIZING OVERLAY LOCATION OVER PROGRAMMING CONTENT

(71) Applicant: Overplay, Inc., Campbell, CA (US)

(72) Inventors: Robert Ryan, Saratoga, CA (US); Mitchell Kahn, San Jose, CA (US)

(21) Appl. No.: 15/984,378

(22) Filed: May 20, 2018

Related U.S. Application Data
(62) Division of application No. 15/630,821, filed on Jun. 22, 2017.
(60) Provisional application No. 62/353,729, filed on Jun. 23, 2016.

(51) Int. Cl. H04N 21/488; H04N 21/235; H04N 21/414; H04N 21/234

(52) U.S. Cl. CPC H04N 21/4886; H04N 21/235; H04N 21/23424; H04N 21/41407

(57) ABSTRACT

A system is disclosed for providing a platform for optimizing overlay location over programming content that is distributed over a channel by a content provider and displayed on a display at an establishment, the system comprising one or more servers that communicates with a client over a network, each server including one or more processors, memory and one or more programs stored in the memory, the one or more programs comprising instructions for: generating an overlay with information in response to a request from a user via the client that communicates with the one or more servers over the network; and positioning the overlay over programming content from the content provider that is distributed over the channel and displayed on the display at the establishment, wherein the overlay is positioned over programming content so that the overlay does not interfere with one or more tickers transmitted by the content provider over the programming content.

### CROSS REFERENCE TO RELATED APPLICATIONS

This application is a divisional application of U.S. application Ser. No. 15/630,821, filed Jun. 22, 2017 which claims priority to U.S. provisional application No. 62/353,729, filed Jun. 23, 2016 entitled “System and Method for Providing a Platform for Optimizing Overlay Location Over Programming Content” which are incorporated by reference herein.

### FIELD OF INVENTION

The present invention relates to a system and method for providing a platform for optimizing overlay locations over programming content.

### BACKGROUND OF THE INVENTION

Cable networks commonly user tickers (also called crawlers) over programming content to disseminate information to their viewers. Ticker information may include weather warnings, school closings, stock quotes and election results to name a few. Tickers are often used during live or recorded programming content such as sporting events that are distributed (or aired on) over a particular channel by a content provider. Examples of these tickers include sports statistics as well as progress updates on other sporting events distributed over other channels. Traditional tickers are displayed in the form of scrolling text and/or graphics running across the bottom or top of a screen. ESPN, for example, transmits a ticker over programming content on the bottom of a display screen. Tickers, however, may appear in different locations at various times depending on ticker content itself, time of day, programming content and particular desires of the cable networks.

Now, in any given commercial establishment (also referred to as a venue) such as a bar, there could be any number of mounted or free standing displays, each of which showing the same or a different sporting events. Patrons of these establishments or venues are essentially considered a captive audience whether or not they desire to view a displayed sporting event. This provides opportunities for venues to enhance customer viewing pleasure as well increase sales (e.g. venue product or advertisements). Prior customer viewing enhancements however are limited and traditional mechanisms for advertising are not very effective.

### SUMMARY OF THE INVENTION

A system and method are disclosed for providing a platform for optimizing overlay location over programming content.

In accordance with an embodiment of the present disclosure, a method is disclosed of connecting a mobile device registered to a user with a display among a plurality of displays in an establishment to enable the mobile device to control the operation of the display, the method comprising: computing, by a processor, a plurality of codes for images captured of programming content that is distributed over a plurality of channels from one or more content providers on the plurality of displays in the establishment; receiving an image of programming content displayed on a display in an establishment that is captured by a mobile device registered to a user, wherein the programming content is distributed over a channel of the plurality of channels by the one or more content providers; generating a code for the image captured by the mobile device of the user; comparing, by the processor, the generated code with the plurality of computed codes for the images of programming content; selecting, by the processor, a code from the plurality of computed codes, associated with programming content displayed on the plurality of displays in an establishment, that matches or is nearest in value to the generated code for the image captured by the mobile device of the user; and linking the mobile device to the display in the establishment, thereby enabling the user to control the operation of the display using the mobile device.

In accordance with yet another embodiment of the disclosure, a system is disclosed for providing a platform for optimizing overlay location over programming content that is distributed over a channel by a content provider and displayed on a display at an establishment, the system comprising one or more servers that communicates with a client over a network, each server including one or more processors, memory and one or more programs stored in the memory, the one or more programs comprising instructions for: generating an overlay with information in response to a request from a user via the client that communicates with the one or more servers over the network; and positioning the overlay over programming content from the content provider that is distributed over the channel and displayed on the display at the establishment, wherein the overlay is positioned over programming content so that the overlay does not interfere with one or more tickers transmitted by the content provider over the programming content.

In accordance with yet another embodiment of the disclosure, a method is disclosed of providing a platform for optimizing overlay location over programming content that is distributed over a channel by a content provider and displayed on a display at an establishment, the method implemented by comprising one or more servers that communicate with a client over a network, each server including one or more processors configured to execute the method, the method comprising: generating an overlay with information in response to a request from a user via the client that communicates with the one or more servers over the network; and positioning the overlay over programming content from the content provider that is distributed over the channel and displayed on the display at the establishment, wherein the overlay is positioned over programming content so that the overlay does not interfere with one or more tickers transmitted by the content provider over the programming content.

In accordance with yet another embodiment of the disclosure, a method disclosed of controlling the operation of a display in an establishment by a mobile device that is registered to a user, the display configured to display programming content distributed over a first channel by a content provider, the method comprising: receiving a user selection for a program topic associated with programming content that is not displayed on the display in the establishment; searching, by a processor, for the program topic in a database of program topics that relates the programming content not displayed on the display; determining, by the processor, if the user selected topic matches a topic in the database that relates to the programming content not displayed on the display; and presenting, via the mobile device, an option to select a second channel by a user for programming content associated with the user selected topic, if a match is determined.

In yet another embodiment of the disclosure, a system is disclosed providing for optimizing a location of a user defined overlay over programming content that is delivered over a channel and displayed on a display at an establishment, the system including one or more servers programmed to execute one or more software modules, the one or more modules comprising; a first engine configured to manage registration and authentication of one or more user mobile devices and one or more establishments; a second engine configured to communicate with the first engine, the second engine further configured to (1) register and control operation of one or more control units on the one or more establishments and (2) facilitate overlay selection and positioning over programming content on a display at an establishment so that the overlay does not interfere with one or more tickers transmitted by the content provider over the programming content; and a third engine configured to communicate with the second engine and further configured to receive and process content programming from content providers.

In yet another embodiment of the disclosure, a system is disclosed for providing a platform for optimizing overlay location over programming content that is distributed over a channel by a content provider and displayed on a display at an establishment, the system comprising one or more servers that communicates with (1) equipment at the establishment to facilitate the display of programming content on a display and (2) a mobile device of a user over a network, the one or more servers programmed to execute the method, the method comprising: transmitting a sound signal from the programming content that is distributed over the channel at the establishment to the mobile device of the user, wherein transmitting includes: (1) communicating over the network between the equipment at the establishment and the one or more servers; and (2) communicating over the network between the one or more servers and the mobile device.

### BRIEF DESCRIPTION OF THE DRAWINGS

FIG. 1A depicts a block diagram of an example system in which a platform for optimizing overlay location over programming content operates.

FIG. 1B depicts a block diagram of another example system in which a platform for optimizing overlay location over programming content operates.

FIG. 2A depicts an example architecture of platform 200 for optimizing overlay location over programming content including several modules/applications and databases.

FIG. 2B depicts functional components for certain modules shown in FIG. 2A.

FIG. 3 depicts an alterative example establishment of the system shown in FIG. 1.

FIG. 4 depicts method steps associated with the platform for optimizing overlay location over programming content.

FIG. 5 depicts method steps associated with using the platform for optimizing overlay location over programming content.

FIG. 6 depicts method steps for automatically changing channels based on a topic selected by a user for programming content.

FIG. 7 depicts example method steps of the platform 200 for linking a mobile device to a display in an establishment.

FIG. 8 depicts a block diagram of example system in FIG. 1B illustrating the operation of sound broadcast via the mobile device.

FIGS. 9-14 depict various images on a display and mobile device in connection with the platform for optimizing overlay location over programming content.

### DETAILED DESCRIPTION OF THE INVENTION

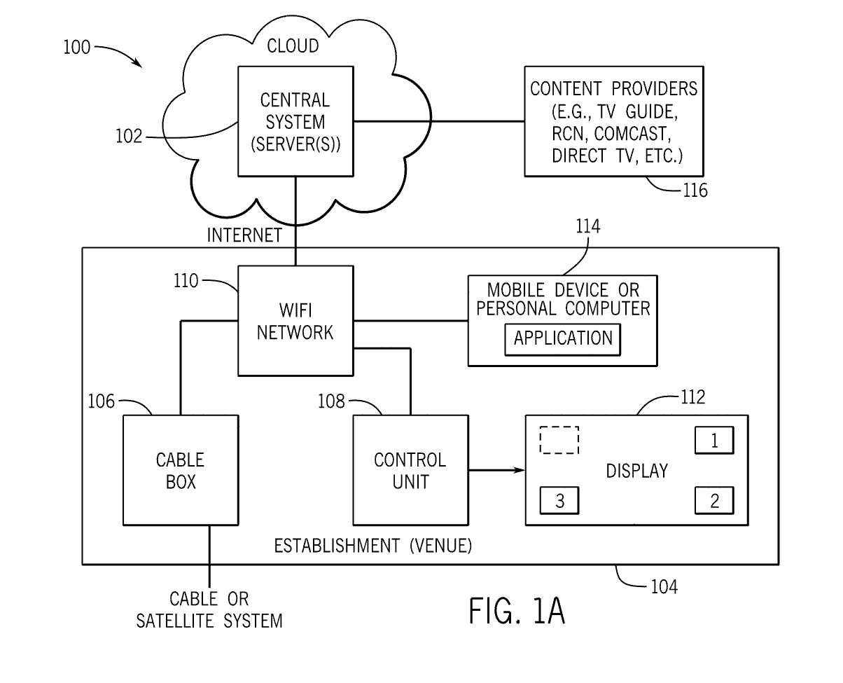

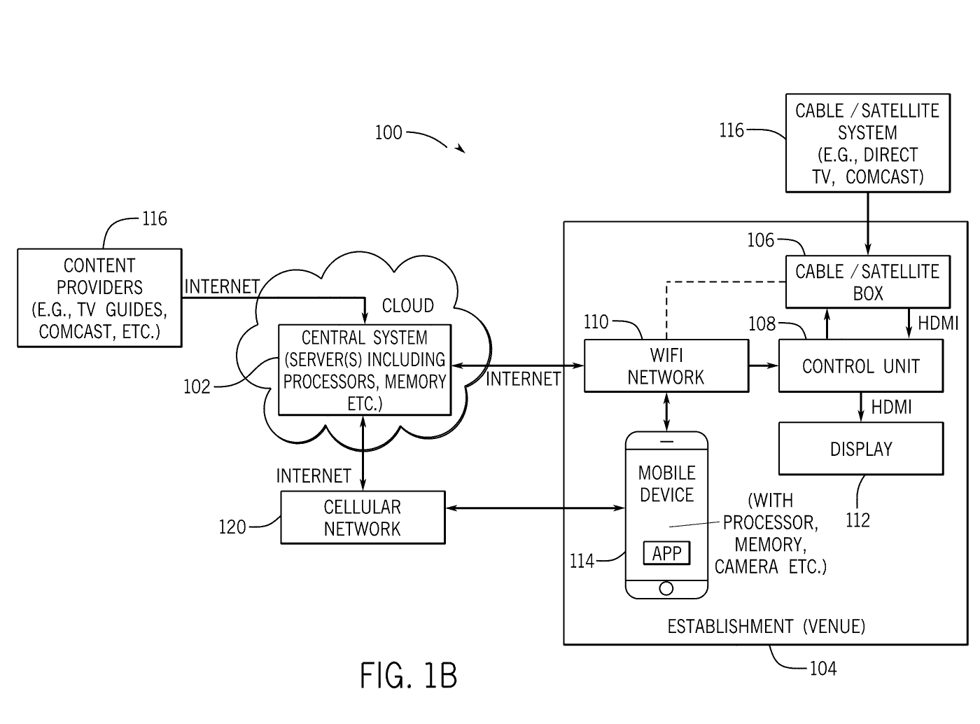

FIG. 1A depicts a block diagram of an example system 100 in which a platform (discussed in detail below) for optimizing overlay location over programming content operates. Specifically, this platform enables a user to select an overlay and automatically determines the optimal location for the overlay (and positions it) based on programming content and/or overlay information. Alternatively, the platform enables a user to select the overlay position over (on top of) programming content. Overlay is information or content displayed horizontally, vertically or otherwise over programming content. Overlay information or content may be text, images or any other data desired by a user. The programming content may be content from content providers such as broadcast television stations, cable networks, satellite systems, Internet, TV Guide or any other source for programming content. The content may be live programming or recorded. (The terms data and information may be used interchangeably herein.)

System 100 includes central system 102 and establishment 104 that is configured to access program modules/applications and data (as described below) from central system 102 via a network such as the Internet. Central system 102 is shown in FIG. 1A in the cloud, as known to those skilled in the art, whereby central system 102 is located remotely from client 114 (as described below), but communicates with client 114 through one or more nodes on the network (e.g., Internet). Establishment 104 may communicate with central system 102 over the network, such as the Internet, via a wired connection (e.g., cable, Ethernet) or wirelessly (e.g., WIFI or wireless carrier networks) as known to those skilled in the art. An administrator may access central system 102 through a connected client (not shown) to control the operation of the platform for optimizing overlay location over programming content. This client may be on site or remotely connected to central system 102 over the Internet and/or local area network (LAN). The client may be a personal computer (e.g., desktop or laptop) or display or a mobile device as described herein.

Central system 102 comprises one or more servers that are typically connected via a local area network (LAN). The one or more servers may include a web server. Each server includes several internal components (e.g., processor, memory, drives, storage such as hard drives/SSDs, network cards, video cards etc.), operating system, databases, software modules and applications (e.g., browser) as known to those skilled in the art. Central system 102 is configured to receive channel information, programming content and ticker information from content providers 116. Examples of content providers include cable companies such as Comcast and RCN, Satellite providers such as Direct TV or TV Guide. Ticker, also referred to as crawler or slide, is a narrow area of information typically across the top or bottom of a television or computer screen as known to those skilled in the art. The information may be news, graphs, scoreboards or other information or content transmitted along with programming content to enhance the viewing pleasure of the viewers.

Establishment or venue 104 may be a commercial or governmental establishment or facility (e.g., bar, restaurant, hospitality suite, sporting arena, airport etc.) that is owned and/or operated by one or more users (commercial users). However, an establishment 104 may be a user residence (residential users). In the example shown, establishment 104 comprises equipment including cable box 106 (or Satellite box and/or other equipment), control unit 108 and display 112. Cable box 106, as known to those skilled in the art is configured to receive programming content from content providers (as described above) and for transmit such content for user viewing. Cable box 106 communicates with display 112 via control unit 108. Specifically, control unit 108 (e.g., box or board) is connected to cable box 106 wirelessly via WIFI network 110 or wired connection (not shown) and a display 112 (may also referred to as a television, monitor or computer screen). Display 112 is configured to receive and display the programming content to be viewed by one or more users as known to those skilled in the art. Control unit 108 incorporates cable jacks/connectors to connect directly to cable box 106 and display 112 using conventional coaxial cables as known to those skilled in the art. Control unit 106 comprises a processor, memory and operating system as known to those skilled in the art. The operating system is a variant of Linux but those skilled in the art know that any other operating system may be used to achieve desired results. Control unit 108 is configured to access modules and data from central system 102 as discussed in more detail below.

Mobile device or personal computer each includes several internal components (e.g., processor, memory, drives, storage such as hard drives/SSDs, network cards, speaker(s), sound processing technology, video cards, camera (mobile device) etc.), operating system, databases, software modules and applications (e.g., browser) as known to those skilled in the art. Mobile device or personal computer 114, as known to those skilled in the art, incorporates several applications, one of which is used to access modules and features of modules and databases of platform 200 for optimizing overlay location over programming content. Mobile device and personal computer 114 are also referred to as a client (or client 114).

FIG. 1B depicts a block diagram of another example system in which a platform for optimizing overlay location over programming content operates. System 100 includes most of the same components (and functionality) as shown in FIG. 1A. System 100 includes central system 102 and establishment or venue 104 that is configured to access program modules/applications and data (as described below) from central system 102 via a network such as the Internet. Central system 102 is shown in FIG. 1B in the cloud, as known to those skilled in the art, whereby central system 102 is located remotely from client 114 (as described below) but communicates with client 114 through one or more nodes on the network (e.g., Internet). Establishment 104 may communicate with central system 102 over a network, such as the Internet, via a wired connection (e.g., cable, Ethernet) or wirelessly (e.g., WIFI or wireless carrier networks) as known to those skilled in the art. An administrator may access central system 102 through a connected client (not shown) to control the operation of the platform for optimizing overlay location over programming content. This client may be on site or remotely connected to central system 102 over the Internet and/or local area network (LAN). The client here is a mobile device as described herein, but it may be a personal computer as described above.

System 100 further includes equipment such as cable/satellite box 106, control unit 108 and display 112. In this example, control unit 108 may communicate with cable/satellite box 106 through HDMI, WIFI and/or Ethernet as known to those skilled in the art. Client 114 may communicated with central system 102 via cellular network 120 or WIFI network 110.

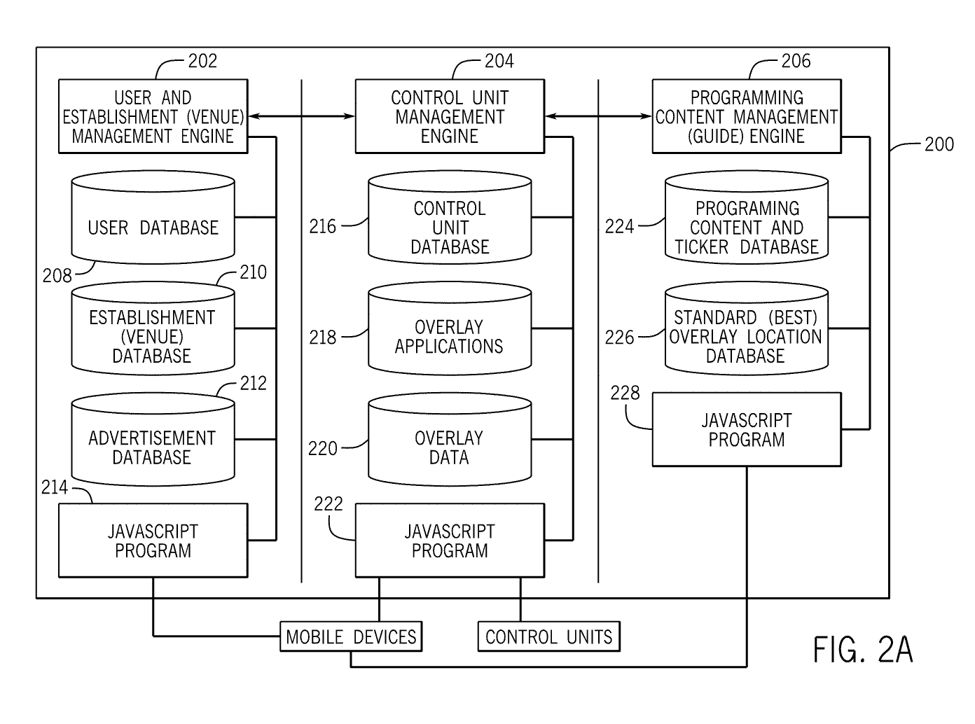

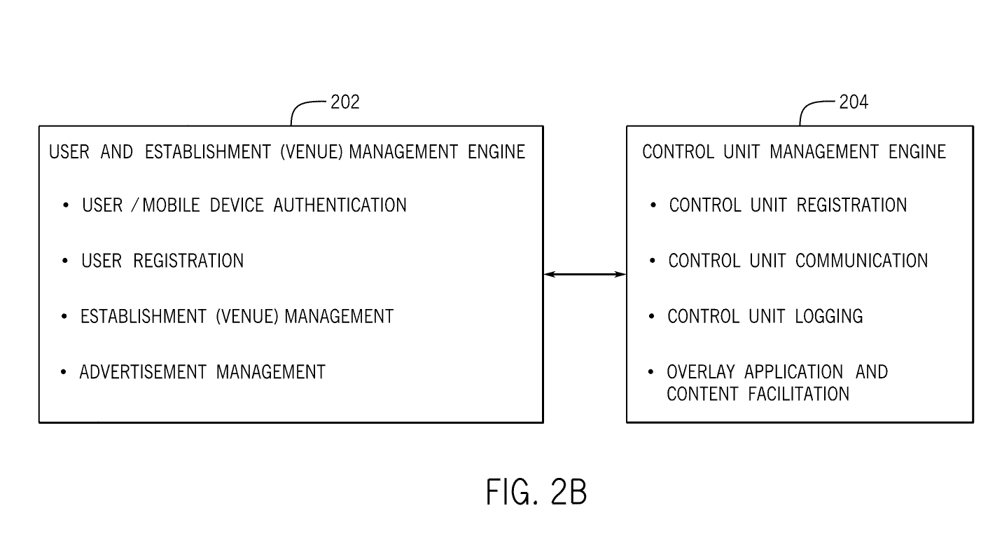

FIG. 2A depicts an example architecture of platform 200 for optimizing overlay location over programming content including several modules/applications and databases of platform 200. The architecture shown is broken down into three areas or columns (separated by dashed lines), each of which depicts a module and several databases. As described in detail below, the modules and databases work together to achieve desired functional results. As stated above, this architecture is an example configuration of the modules and databases of platform 200. However, those skilled in the art know that the architecture may have a configuration with any number of modules and databases (e.g., additional, less than, or combinations of those modules/databases) to achieve desired results as described herein. The architecture shown in FIG. 2A may be embodied in a single server or any number of servers (and mobile device).

For the architecture shown in FIG. 2A, platform 200 comprises software modules including user and establishment (venue) engine 202, control unit management engine 204 and programming content management engine 206. These engines communicate with each other as shown and described below. Platform 200 further comprises several databases including user database 208, establishment (venue) database 210, advertisement database 212, control unit database, 216, overlay applications database 218, overlay database 220, programming content and ticker database 224, and standard/best location (for overlay) database 226.

User and establishment (venue) engine 202 is configured to operate core functions of platform 200 including user/mobile device authentication, user registration, establishment (venue) management and advertisement management. Details are shown in FIG. 2B. For example, user accounts are created and management functions are performed by user and establishment management engine 202.

User database 208, is a database as known to those skilled in the art, for storing registered users of platform 200 such as commercial users (i.e., owners or operators) of establishments 104 along with actual establishment information as well as customers of such establishments.

Establishment database 210, is a database as known to those skilled in the art, for storing establishment (venue) information including name and location there the establishment.

Advertisement database 212 is a database, as known to those skilled in the art, for storing advertisements that registered advertisers have provided. Platform 200 automatically applies advertisements as part of the overlays to registered users, under a user's control.

User and establishment management engine 202 communicates with user database 208, establishment (venue) database 210 and advertisement database 212.

Control unit management engine 204 is configured to communicate with the individual control units at the various establishments, register the control units and log the operation of the control units. Engine 204 is further configured to serve up (facilitate the operation of) overlay applications as well as the overlay information (content) that is overlayed over programming content on a display at an establishment. These functions are shown in FIG. 2B. As indicated above, control unit management engine 204 communicates with user and establishment management engine 202. If a user wants to know the addresses of certain control units in the establishments A, B and C, then engine 202 retrieves this address information from user and establishment management engine 202. If a user is logged into platform 200 and wants to find out why a control unit continues to crash, at a user's request, user and establishment management engine 202 will retrieve the logging information from control unit management engine 204 for display.

Control unit database is a database, as known to those skilled in the art, for storing control unit information including addresses and logging information.

Overlay application database is a database, as known to those skilled in the art, for storing actual overlay applications that access the overlay data from overlay database 222 and overlay such data over programming content.

Overlay database, is a database as known to those skilled in the art, for storing overlay data used by overlay applications. For example, one establishment or venue may run an overlay application to scrape tweets relating to Guinness Stout for an overlay, while another establishment may run an overlay application to scrape tweets relating to Budweiser. This information or data is stored in the overlay database.

Programming content management engine 206 is configured to receive and process content programming from content providers such as Comcast, RCN, DirectTV and/or third party providers such as TV Media that provide programming content from several providers and a generate a guide of the programming content for subsequent use. In short, engine 206 downloads programming content, reformats and stores it in the programming content and ticker database 224. Engine 206 is further configured to receive and process ticker information and to determine the best location(s) on a display for overlay position based on the ticker location and its content as well as any programming content so that the overlay does not interfere with the ticker and/or that programming content. The best locations are also referred to as standard overlay locations.

Programming content and ticker database 224 is a database, as known to those skilled in the art, for storing programming content and ticker information (e.g., location) communicated by programming content management engine 206.

Standard overlay location database, is a database as known to those skilled in the art, for storing the standard (best) locations for overlay information.

Platform 200 further comprises Javascript programs 214, 222, 228 that enable the mobile devices and control units to communicate with the modules and databases of platform 200.

A mobile app of platform 200 communicates with user and establishment management engine 202 to enable a user to login, communicates with control unit management engine 204 to control operation of the control unit and communicates with programming content management engine 206 to retrieve programming content information. In practice, a user may login to platform 200 via user and establishment management engine 202, select a particular establishment or venue and view a list of displays in that establishment and channel programming content appearing on those displays via control unit management engine 204 and programming content management engine 206. The user also has the option to view the particular overlay applications along with overlay content. The user may select a display and channel for desired programming content for viewing. Alternatively, a user may change a channel to a channel carrying ESPN3 and control unit management engine 204 will retrieve the ESPN3 programming content via programming content engine 206 for a period of time (e.g., 4 hours) along with the best positions for the overlay to avoid interference with the ticker and/or programming content.

There may be other databases such as a customer database for storing customers (users) of the registered establishments (e.g., establishment 104). These customers may engage with other registered customers (users) for games, competitions and other activities such as fantasy football. Platform 200 may include another registration module configured to register these customers or configure the user and establishment management engine 202 to perform this function. As indicated above, user and establishment engine 202 is configured to perform advertiser registration to register advertisers and integrate target advertisement automatically or as selected by establishment users (operators). Platform 200 may have links to social networks or other websites or apps for users to engage with each other.

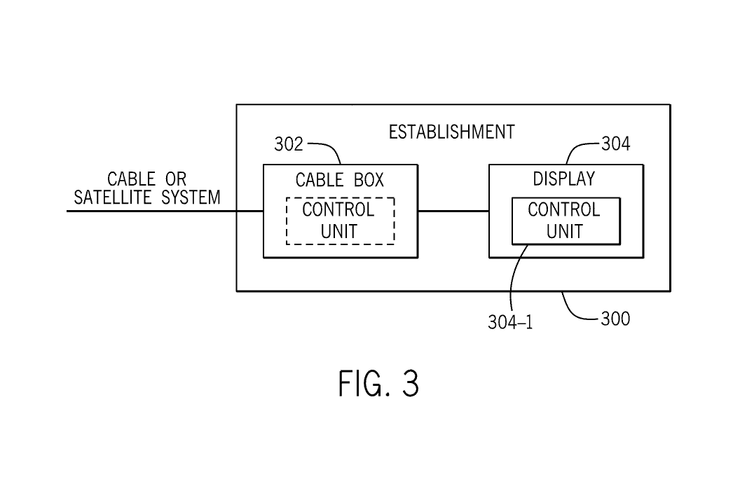

FIG. 3 depicts an alterative example establishment 300 of the system 100 shown in FIG. 1 illustrating component details. Similar to the establishment shown in FIG. 1, establishment 300 includes cable box 302 and display 304. (The WIFI network is not shown but it communicates similarly with the control unit. Also, the mobile device or personal computer is also not shown but one or both are part of the establishment.) However, in this embodiment, display 304 incorporates control unit 304-1 as part thereof. There is no separate control box or unit. Control unit 304-1 functions similarly to control unit 108, but is now part of display 304. Alternatively, the control unit may be part of cable box 302 itself (as shown in dashed lines). Regardless, the control unit may be configured as hardware, software or both to achieve the same functionality.

In practice, a user will install a control unit at his/her establishment between his/her cable box 106 (or other programming content box) and display 112. Then, the user will download and install the mobile application on his/her mobile device or personal computer (or alternatively user access via website). Upon installation, the user will register his/her establishment (establishment) and such user information will be stored in the user database 208 along with an identification reference for the control unit.

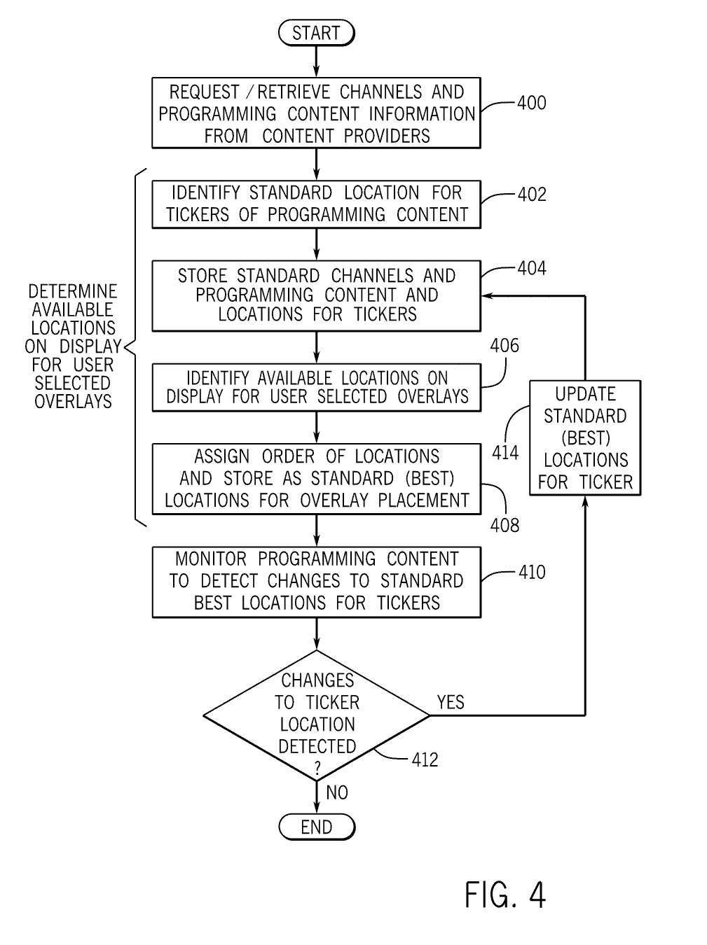

FIG. 4. depicts method steps associated with platform 200 for optimizing overlay location over programming content. In particular, execution begins at step 400 wherein control unit 108 requests (retrieves) channel and programming content information from one or more content providers 116. In practice, control box 108 queries one or more content providers (sources) for channel and programming content. For example, the channels may be retrieved from a content provider such as Comcast or other sources via an API as known to those skilled in the art. Then, programming content management engine 206 of platform 200 determines the available locations (spots) on a display for user-selected overlays (placement) by performing steps 402-408.

Specifically, execution proceeds to step 402 wherein standard locations for tickers are identified that are transmitted along with programming content by the content providers. One way to do this is to employ individuals willing to watch the programming content and obtain such ticker information. Other means known to those skilled in the art may also be used to obtain or detect such information such as signal analysis whereby the streams of programming content are analyzed to determine ticker location (e.g., digital signal processing with edge detections, etc.) or other process/mechanism known to those skilled in the art. Ticker location is thus identified for a specific channel, programming content and time of day for such programming content. Next, execution proceeds to step 404 wherein the regular or standard locations for such tickers along with the channel and programming content are stored in the database 404. Then, execution proceeds to step 406 wherein the available locations on a display are identified for the user-selected overlays. These available locations are safe areas in which overlays may be displayed that will not interfere with tickers transmitted with programming content. The available locations for user-defined overlays are thus selected as a function of ticker location, channel and programming content (and time of day). Once these available locations are determined, execution proceeds step 408 wherein the locations are assigned an order for overlay placement and stored in database 226. (Display 112 in FIG. 1 depicts several locations (1, 2, 3) for such overlays that have been assigned. The dashed box in the left hand corner is where an example ticker is placed.) At this point, a database of standard locations (best locations) for overlay content has been created for subsequent use.

Execution then proceeds to step 410 wherein platform 200 monitors the programming content to detect changes in the standard locations for the tickers transmitted by content providers 116. The changes may be determined in several ways. For example, the changes may be determined using mechanical turks, as known to those skilled in the art, whereby individuals bid on the task to manually perform such monitoring. Other ways to determine changes include signal analysis whereby the streams of programming content are analyzed to determine ticker location (e.g., digital signal processing with edge detections, etc.) or machine learning or other process/mechanism known to those skilled in the art whereby platform 200 actually monitors user behavior with respect to such overlay placement. In this way, platform 200 will track registered user behavior to determine where such users are placing overlays on particular channels and programming content. For example, if 1000 registered users have selected an overlay location for a particular channel and program content, then platform 200 will recognize that particular overlay location as the best spot for such overlays. These are examples. Those skilled in the art know that other means for detecting changes in ticker location may be employed.

Now, if a change is detected at decision step 412, then standard locations for such tickers are updated and stored in the database 224 at step 404 and the process repeats. If there are no changes detected, execution ends.

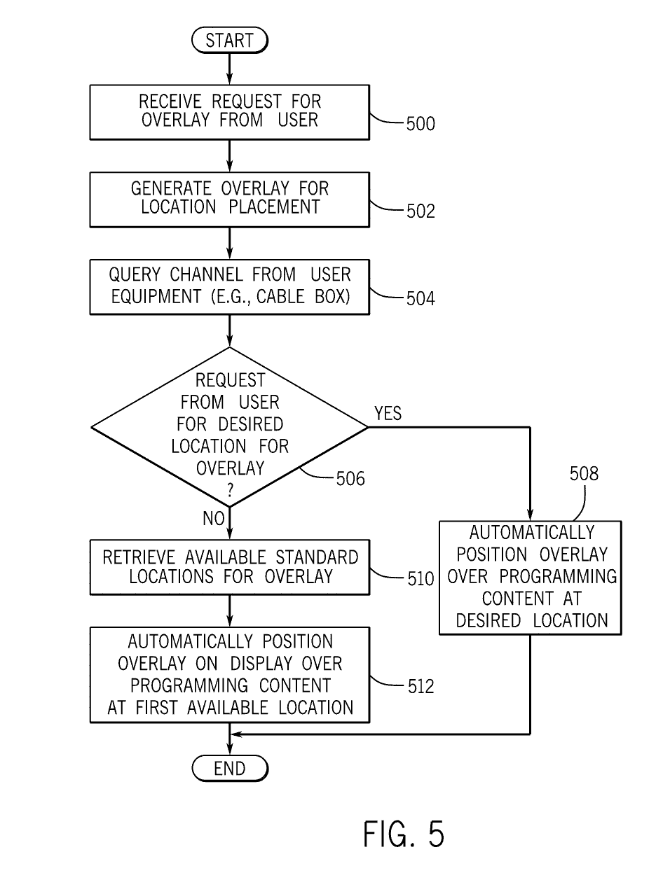

FIG. 5 depicts example method steps associated with using the platform 200 for optimizing overlay location over programming content. In practice, a user initially logs in to the mobile application on his/her mobile device 114 (or website alternatively). Execution proceeds to step 500 wherein the user enters information such as text, images and or other data as desired for an overlay intended to be displayed. Execution then proceeds to step 502 wherein the overlay is generated for subsequent location placement over the programming content. At this point, advertisements designated for a user are inserted into overlays as known to those skilled in the art. Next, execution proceeds to step 504 wherein control unit 108 queries the user's equipment, i.e., cable box 106 for a particular channel set for viewing. If a user has requested a desired location for the overlay content on display 112 at decision step 506, then the user selected overlay is automatically placed over the programming content at the desired location at step 508 and execution ends. If there is no user request for a specific location for the overlay, then execution proceeds to step 510 wherein the standard locations are retrieved that are associated with the particular channel queried. Execution then proceeds to step 512 wherein the overlay is automatically placed over the programming content at the first available location assigned in the order stored and execution ends.

In this respect, the overlay location is optimized for display as a function of ticker location, the channel and programming content (and time of day).

In summary, platform 200 provides the answers to (1) what channel is transmitted and (2) what is the best location or spot for user selected overlay content. As part of this, platform 200 detects the channel signal and its programming content. For example, ESPN may transmit sports programming with its own ticker on the bottom of the screen. A user's overlay would interfere with ESPN's transmitted ticker, thereby making ESPN's ticker un-viewable. Therefore, platform 200 ultimately detects the channel signal, programming content and ticker location to ensure that the generated overlay is positioned in another location on the display that does not interfere with the ESPN transmitted ticker or particular programming content.

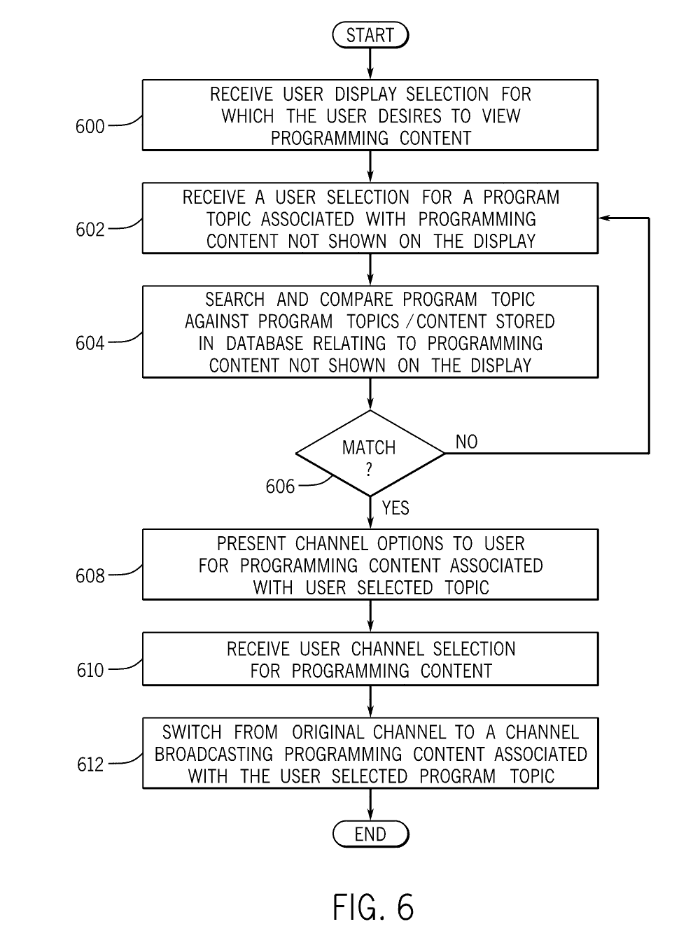

FIG. 6 depicts example method steps of the platform 200 for automatically changing channels based on a topic selected by a user for desired programming content.

Execution begins at step 600 wherein a display selection for which a user desires to view programming content is received. In this respect, the user selected the display for viewing programming content.

Execution proceeds to step 602 wherein a user selection is received for a program topic/content stored in programming content and ticker database associated with particular programming content currently not shown on the display. In this respect, if a user desires to view a particular program such as the Warriors or another basketball game, the user would select from a list of popular topics, “Warriors” or “basketball” (or similar designation) or alternatively type in the topic or name. Then, execution proceeds to step 604 wherein the program topic is searched against stored in the programming content and ticker database relating to programming content now shown on the display. If there is no match at decision step 606, execution returns to step 602. If there is a match at decision step 606, then execution proceeds to step 608 wherein the user is presented with channel options for the programming content that is associated with the user selected topic.

Execution proceeds to step 610 wherein a user channel selection for the programming content is received. In this respect, the user selects a channel for desired programming content.

Execution proceeds to step 612 wherein the original channel showing current programming content to the channel broadcasting programming content associated with the user selected topic. In this respect, platform 200 will automatically switch or change from a current channel of programming content to the channel with desired programming content.

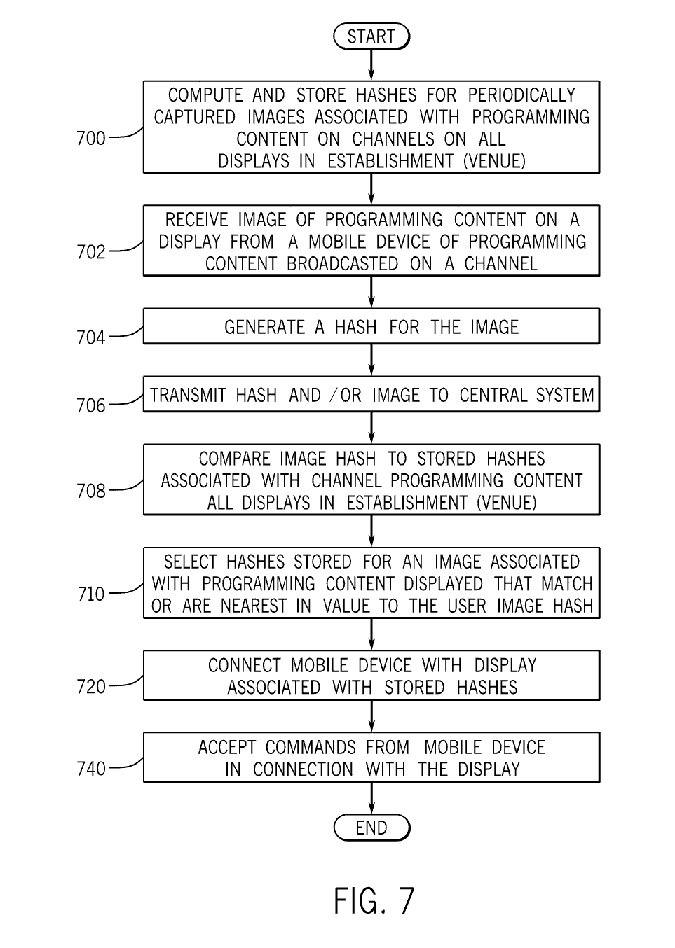

FIG. 7 depicts example method steps of the platform 200 for linking a mobile device to a display in an establishment.

Execution begins at step 700 wherein platform 200 continually (periodically) computes and stores hashes (also referred to as hash values), as known to those skilled in the art, that are associated with (assigned to) images captured (taken) of programming content airing on the channels provided by all content providers, including the content displayed on all displaying in an establishment or venue. Platform 200 is configured to capture and store images of the programming content (by programming content management engine 206) on various channels from multiple content providers, continually and consistently at established or set times. The hashes uniquely identify the various captured images of programming content, over all channels, provided by the content providers.

Next, execution proceeds to step 702 wherein platform 200 will receive a photo or image from a user's mobile device of programming content on a channel displayed on a display in the establishment. A user will use his/her mobile device to capture an image (i.e., take a photo) with the camera inside the mobile. For example, the user may take a photo of the Warriors basketball game.

Execution then proceeds to steps 704 and 706 wherein a hash, as known to those skilled in the art, is generated (i.e., computed) for the user captured image and the hash and/or image is transmitted to the central system for storage and subsequent processing. At this point, platform 200 will compute a hash for the image and the hash and/or image is sent to central system 102 for further processing.

Now, execution proceeds to step 708 wherein the user captured image hash is compared to the stored hashes associated with channel programming content on all displays in that establishment (venue).

Execution then proceeds to step 710. In this step, a stored hash (from step 700) is selected that either matches a hash stored in the database of hashes or is nearest in value to the hash for the user captured image. The selected stored hash for an image as described above is associated with channel programming content on a particular display. In this respect, a display is now identified as the one in which the user desires to control.

Execution then proceeds to step 720 wherein platform 200 now connects or links the user's mobile device with the actual display associated with programming content on a particular display.

Finally, execution proceeds to step 740 wherein the display now accepts commands from the mobile device. For example, if the user wishes to change a channel on that display, he/she can do that now that his mobile device is linked to that display. Execution then ends. In the example shown in FIG. 7, hashes are computed to ultimately identify the channel programming content desired for viewing. However, those skilled in the art know that coding schemes, other than hashes, may be employed to achieve desired results.

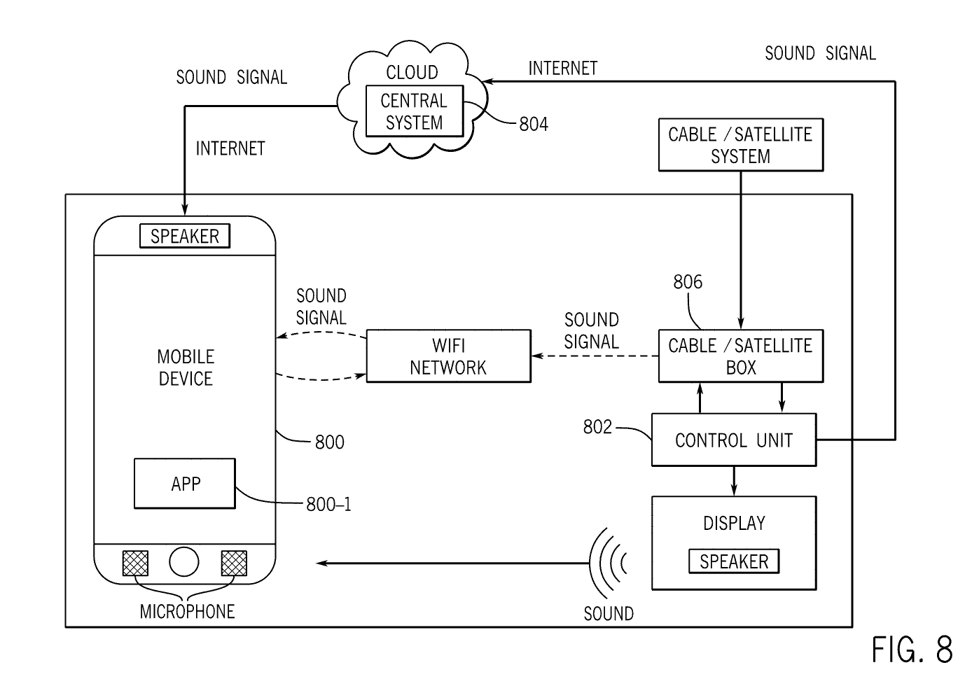

FIG. 8 depicts a block diagram of example system in FIG. 1B illustrating the operation of sound signal via user's mobile device 800. On mobile device 800, the mobile application 800-1 of platform 200 will display a list of displays available for viewing programming content. In one example, mobile application will also display on the screen adjacent the display name an active button/area entitled “Listen” as an option for a user to select. If the user does indeed select this option, i.e., press on the active area on the screen or other representation, then control unit 802 will transmit the sound signal associated with the programming content to central system 804 (in the cloud), and the control unit management engine within central system 804 will transmit the sound signal via a cellular network (not shown) to the mobile application 800-1 of mobile device 800. The application 800-1 will ultimately air the sound signal over the speaker(s) in mobile device 800. The user will thereby hear the sound associated with the programming content over his/her own mobile device. This avoids the difficulty in hearing particular programming content in a noisy venue. Alternatively, the sound signal may be transmitted and received via cable/satellite box 806 and WIFI network directly as shown. In another example, mobile application 800-1 may be listening to the sound airing in the venue from the display, and automatically cause the sound signal to be similarly transmitted and received via the mobile device using these example methods. Regardless of the example method employed used to transmit the sound signal to a mobile device, the sounds signal strength may be configured to enable a user to listen to programming content within the confines of an establishment only to adhere to any applicable copyright or other law.

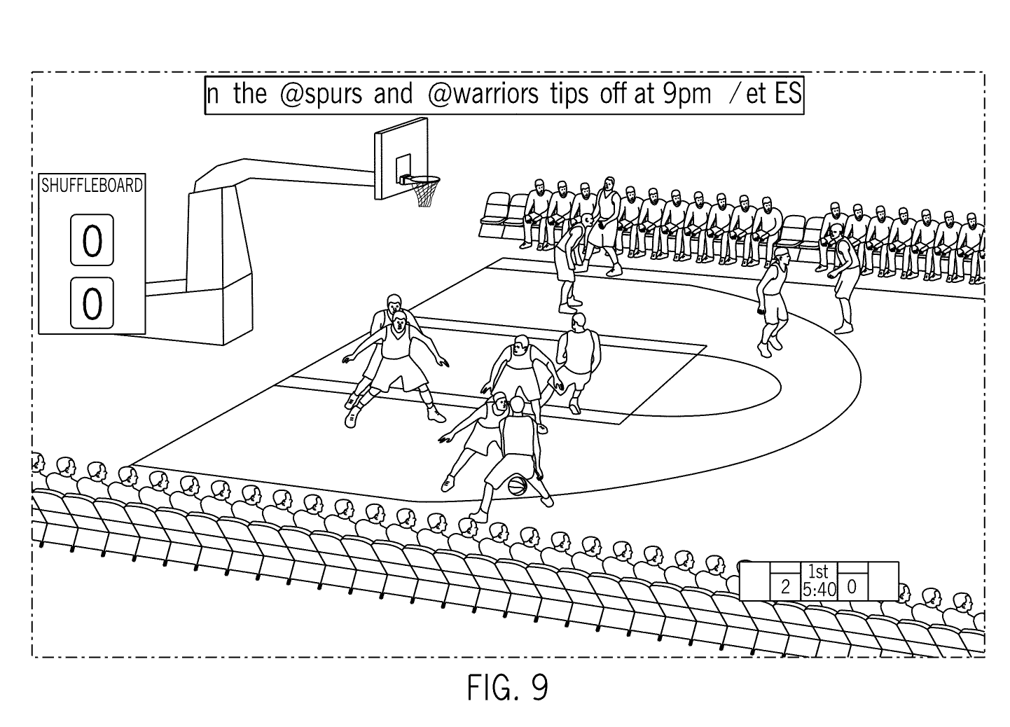

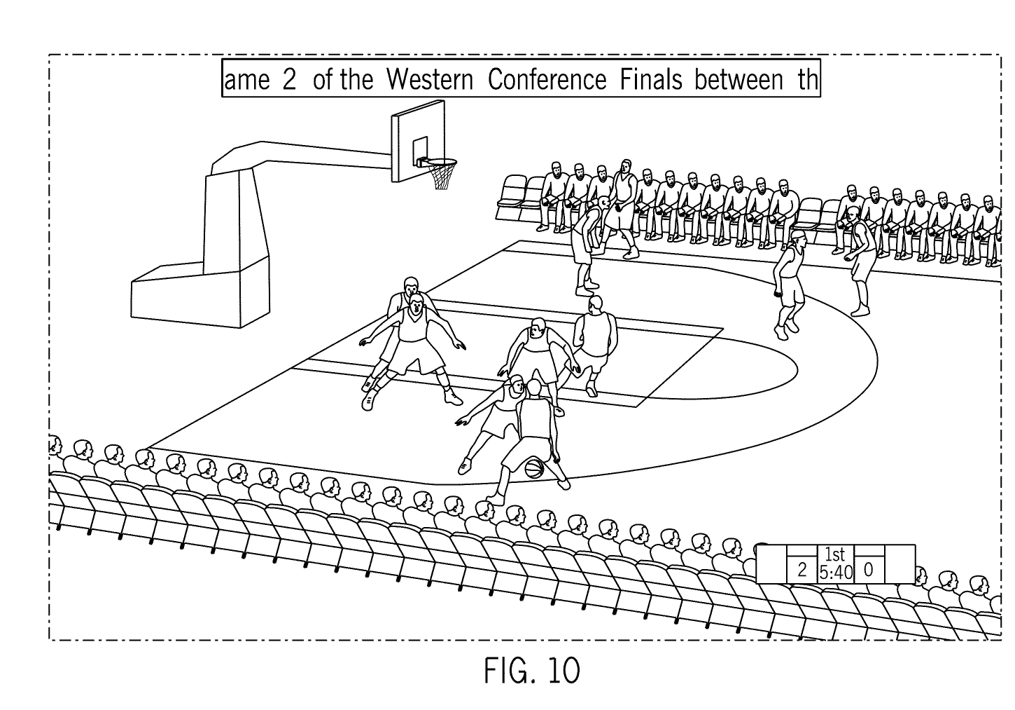

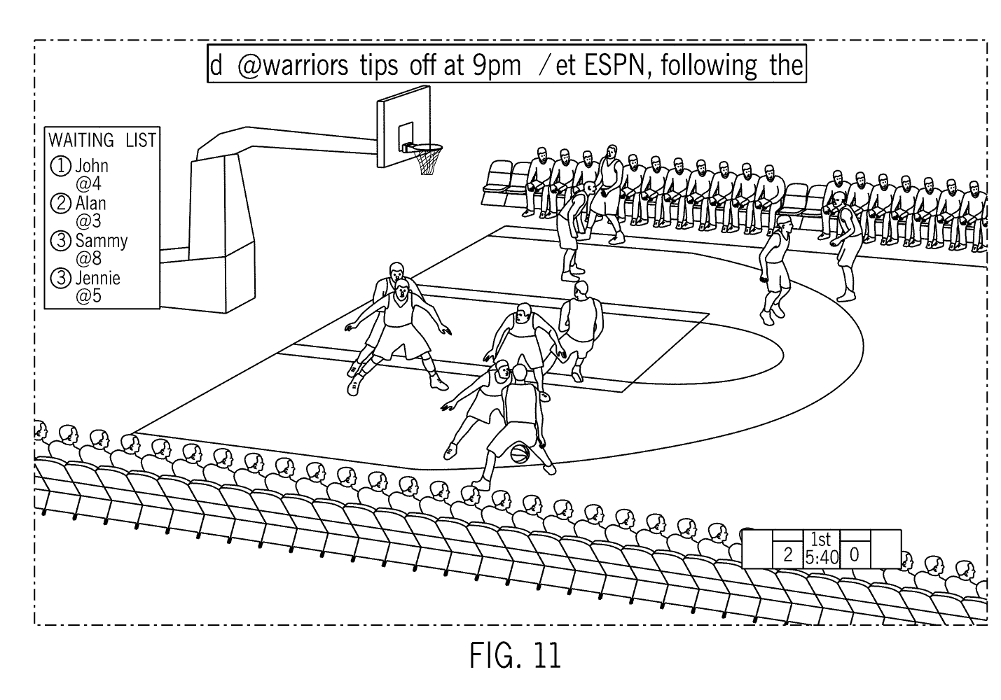

FIGS. 9-14 depict several example images or screenshots from platform 200 on a display or mobile device. In particular, FIG. 9 depicts an example image (basketball from cable feed) on a display showing an overlay across the top and an overlay (Shuffleboard) along the left side of the screen. FIG. 10 depicts an example image of the display showing only one overlay along the top of the screen. FIG. 11 depicts a similar image as in FIG. 9 except the overlay (i.e., box) on the left side of the screen is a waiting list for reservations at a restaurant. (The user will check in via platform 200 or another linked application.) These are examples. As described above, an overlay may be positioned anywhere on a display screen as desired (e.g., moving, scrolling, flashing, stationary, etc.).

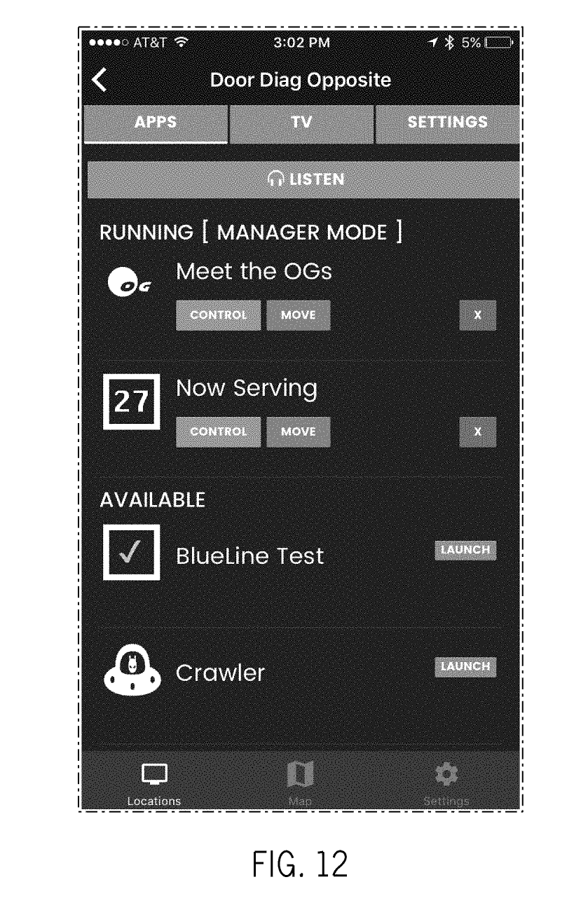

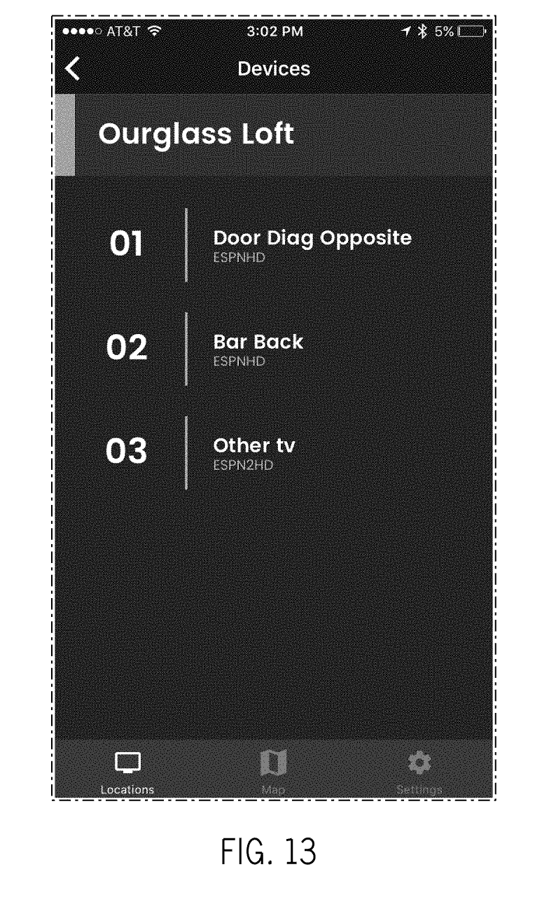

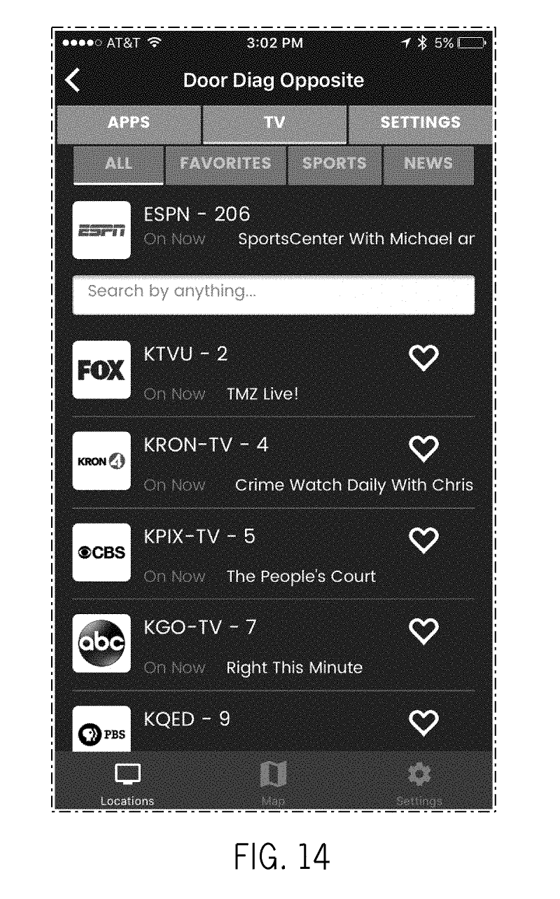

FIG. 12 depicts an image of an example main screen (user interface) on a mobile device wherein a user may control or launch all applications on a remote display. FIG. 13 depicts an image (user interface) on a mobile device wherein a user may select a display (television) to control. FIG. 14 depicts another image (user interface) on a mobile device wherein a user may select a particular channel for viewing.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A method of controlling the operation of a display in an establishment by a mobile device that is registered to a user, the display configured to display programming content distributed over a first channel by a content provider, the method comprising:
receiving a user selection for a program topic associated with programming content that is not displayed on the display in the establishment;
searching, by a processor, for the program topic in a database of program topics that relates the programming content not displayed on the display;
determining, by the processor, if the user selected topic matches a topic in the database that relates to the programming content not displayed on the display; and
presenting, via the mobile device, an option to select a second channel by a user for programming content associated with the user selected topic, if a match is determined.

2. The method of claim 1 further comprises receiving the second channel selection by the user for the programming content associated with the user selection for the program topic.

3. The method of claim 2 further comprises switching from the first channel with programming content to the second channel with the programming content that is associated with the user selected program topic.
